(19) United States
(12) Patent Application Publication
(10) Pub. No.: US 2008/0273672 A1
(43) Pub. Date: Nov. 6, 2008

(54) Automated attendant grammar tuning

(75) Inventors: Clifford N. Didcock, Sammamish, WA (US); Michael Geoffrey Andrew Wilson, Sammamish, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/800,112

(22) Filed: May 3, 2007

(51) Int. Cl. H04M 1/65; G10L 15/06

(52) U.S. Cl. 379/88.01; 704/251

(57) ABSTRACT

A system provides speech-enabled automated attendant call processing. A database comprises words that are anticipated to be received in a voice input. Stored in relation to the words are actions to be taken upon receipt of a call comprising to particular words. A server receives a call, and after playing a prompt, receives a voice input. The server identifies whether words in the voice input correspond to words in the database. If so, the server takes an action stored in the database in relation to the words in the voice input. If words in the voice input do not correspond to words in the database, the server queues the voice input for analysis. In response to inputs, the server adds words from the voice input to the database.

### BACKGROUND

Automated attendant systems are often used in connection with voicemail, call center, and help-desk services. Typically, automated attendant systems provide an automated voice-prompted interface that allows callers to identify a particular entity, e.g., person, department, service, etc. that the user wishes to connect to. For example, an automated attendant system may provide voice prompts such as the following: “press 1 for sales” ; “press 2 for service calls” or “press 3 for information regarding an existing service request.” In response to an input from the user, an automated attendant may connect the caller to the particular person or department that the user identified.

Some automated attendant systems employ speech recognition technology. In systems using speech recognition, user inputs may be received as voice inputs rather than through dual tone multi-frequency (“DTMF”) signals created using a phone key pad. For example, an automated attendant system may prompt the user as follows: “say ‘sales’ to be connected to a sales representative;” “say ‘service’ to request a service call;” or “say ‘status’ to check the status of an existing service request.” An automated attendant system may receive the user's voice input made in response to the prompt and connect the user to the identified person or organization.

### SUMMARY

In the subject matter described herein, a system provides automated attendant call processing.

An illustrative system may comprise a database of words and/or phrases that are expected in voice inputs. The database may further define actions to be taken in response to a voice input that comprises a particular word and/or phrase. For example, the database may define that for a particular word and/or phrase in a voice input, the phone call is to be communicated to a particular individual or department at a particular phone number.

The illustrative system may further comprise a server that is adapted to receive a call and announce a voice prompt. The server is further adapted to receive and record a caller's voice input and determine whether the voice input corresponds to words and/or phrases in the database of words expected in voice inputs. If the server determines that the voice input corresponds to words and/or phrases in the database, the server takes the action specified in the database as corresponding to the particular words in the voice input. For example, if the information in the database identifies that the call should be communicated to a particular person or organizational department, the server communicates the call to the appropriate phone number.

If the server determines that the voice input does not correspond to words in the database, the server queues the voice input for future analysis. The server ultimately receives an input identifying what action was taken in response to the particular voice input and stores this in relation to the voice input. For example, the server may receive an input identifying that the call was ultimately communicated to a particular organizational department.

The server may compare the voice input to previously received voice inputs that were similarly found not to correspond to words in the database and likewise ultimately determined to be requesting the same action. Server may identify words occurring in both the voice input and the previously received voice inputs as being candidates for adding to the database of words expected in voice inputs. Upon receipt of an input identifying voice input that should be added to the database, server adds the words to the database.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

The foregoing summary and the following additional description of the illustrative embodiments may be better understood when read in conjunction with the appended drawings. It is understood that potential embodiments of the disclosed systems and methods are not limited to those depicted.

FIG. 1 is a network diagram of an illustrative computing arrangement in which aspects of the subject matter described herein may be implemented.

FIG. 2 is a block diagram of functional components comprised in an illustrative automated attendant system.

FIG. 3 is a flow diagram of an illustrative process for receiving calls for which automated attendant servicing is to be provided.

FIG. 4 is a flow diagram of an illustrative process for analyzing voice inputs received by an illustrative automated attendant system.

FIG. 5 is a flow diagram of an illustrative process for analyzing voice inputs received by an illustrative automated attendant system.

FIG. 6 is a block diagram of an illustrative computing environment with which aspects of the subject matter described herein may be deployed.

### DETAILED DESCRIPTION OF ILLUSTRATIVE EMBODIMENTS

Overview

The subject matter disclosed herein is directed to systems and methods for providing automated attendant functionality with automated speech recognition. An illustrative system may comprise a database, which may be referred to as a grammar, that comprises words and/or phrases that are expected to be received in response to voice prompts. The database also has stored in relation to each word or set of words expected to be received, an action that is to be taken upon receipt of a voice input identifying the particular word or set of words. The identified action may be, for example, to communicate the call to a particular phone number. An illustrative system may further comprise an automated attendant server that is adapted to prompt users for inputs, receive and process voice inputs from the users, and facilitate updating the database of words and/or phrases to account for unexpected words and/or phrases that are received in user voice inputs.

In a disclosed embodiment, the database of words and phrases is tuned to the expected user voice inputs. In other words, the database of words and phrases is updated to incorporate new words and phrases that users have shown an inclination to use. Tuning of the grammar database contributes to providing a service that, even while providing relatively short and open-ended prompts, is able to understand user's natural voice inputs.

The disclosed systems and methods may be implemented in commercial software and standard hardware. For example, in an embodiment of the disclosed systems and methods, the automated attendant may be implemented in a unified messaging server. Further, the unified messaging server may be implemented on standard computing hardware and may communicate using established networking technology and protocols.

Example Computing Arrangement

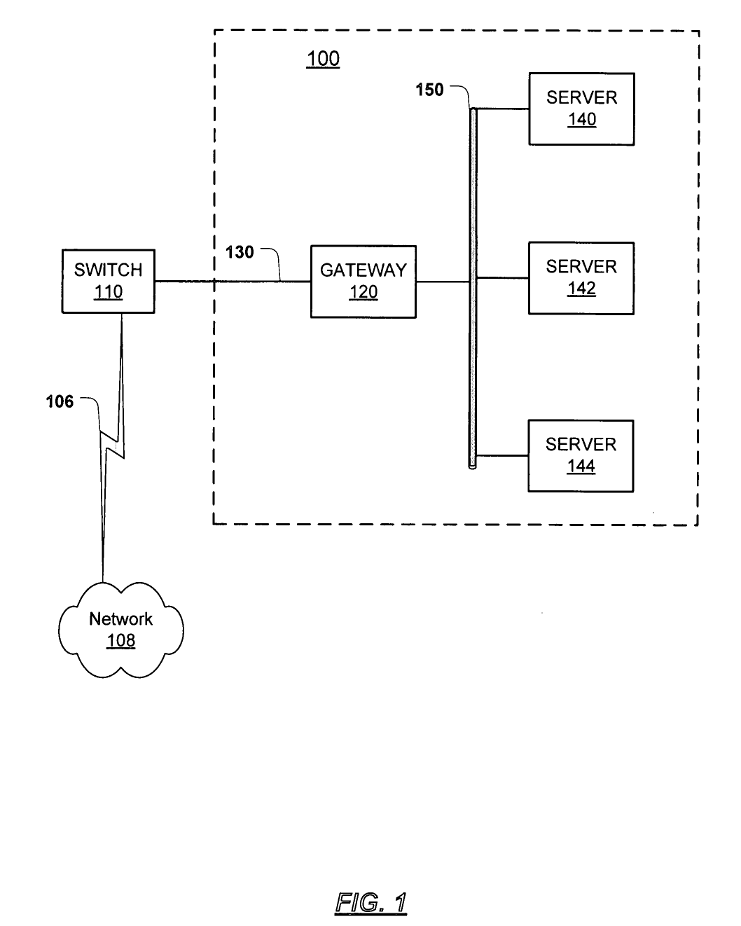

FIG. 1 illustrates an exemplary computing arrangement 100 suitable for providing automated attendant services. As shown, computing arrangement 100 is communicatively coupled with network 108. Network 108 is adapted to communicate voice calls and may be any type of network suitable for the movement of voice signals and/or data. For example, network 108 may be, or may comprise all, or a portion of, a public switched telephone network, the Internet, or any other network suitable for communicating voice information. Network 108 may comprise a combination of discrete networks which may use different technologies. For example, network 108 may comprise local area networks (LANs), wide area networks (WAN's), or combinations thereof. Network 108 may comprise wireless, wireline, or combination thereof.

Network 108 interfaces with switch 110 via communications link 106 to communicate voice calls to computing arrangement 100. Switch 110 may be any type of device that is operable to switch calls from network 108 to computing arrangement 100. In an exemplary embodiment, switch 110 may be, for example, a public branch exchange (PBX) switch. Switch 110 communicates information with gateway 120 via communications link 130, which may use, for example, any suitable network topology suitable for communicating call information.

Computing arrangement 100 comprises gateway 120 and servers 140, 142, and 144. Gateway 120 is adapted to provide an access point to machines including servers 140, 142, and 144 in computing arrangement 100. Gateway 120 may comprise any computing device suitable to route call information to servers 140, 142, and 144. In an example embodiment, gateway 120 is adapted to receive call information in a first protocol from switch 110 and communicate it to servers 140, 142, and/or 144 in another protocol. For example, gateway 120 may be a voice-over-internet-protocol (VoIP) gateway that is adapted to receive voice calls from switch 110 in a circuit switched protocol such as, for example, time division multiplexed (TDM) protocol, and to communicate calls to servers 140, 142, and/or 144 using packet switched protocols such as, for example, internet protocol. In an example embodiment, the functionality of gateway 120 and switch 110 may be combined in a common device.

Network 150 provides a communications link between and amongst gateway 120 and servers 140, 142, and 144. Network 150 may be any communications link that is suitable to provide communications between gateway 120 and servers 140, 142, and/or 144. Network 150 may comprise, for example, a fiber optic network that is suitable for communicating data in an internet protocol format. Further, network 150 may comprise components of networks such as, for example, WAN's, LAN's, and/or the Internet.

Servers 140, 142, and 144 are computing devices that are adapted to provide automated attendant call processing, amongst other services. Each of servers 140, 142, and 144 may be any suitable computing device that has been programmed with computer-readable instructions to operate as described herein to provide automated attendant call processing. In an example embodiment, servers 140, 142, and 144 may programmed to operate as unified messaging (UM) servers adapted to integrate different streams of messages into a single in-box. It is noted that while three servers 140, 142, and 144 are depicted in FIG. 1, any number of plurality of servers may be comprised in arrangement 100.

In an exemplary embodiment, upon receipt of a call at gateway 120, at least one of servers 140, 142, and/or 144 is identified to service the request. The call is forwarded to the one or more servers identified as having responsibility for servicing the call. The one or more servers 140, 142, 144 provide an automated attendant interface system—i.e., a voice prompted interface for identifying an action to be taken in response to the call. The caller may specify the action that he or she wishes to take which typically involves identifying a person or department with which the caller wishes to speak.

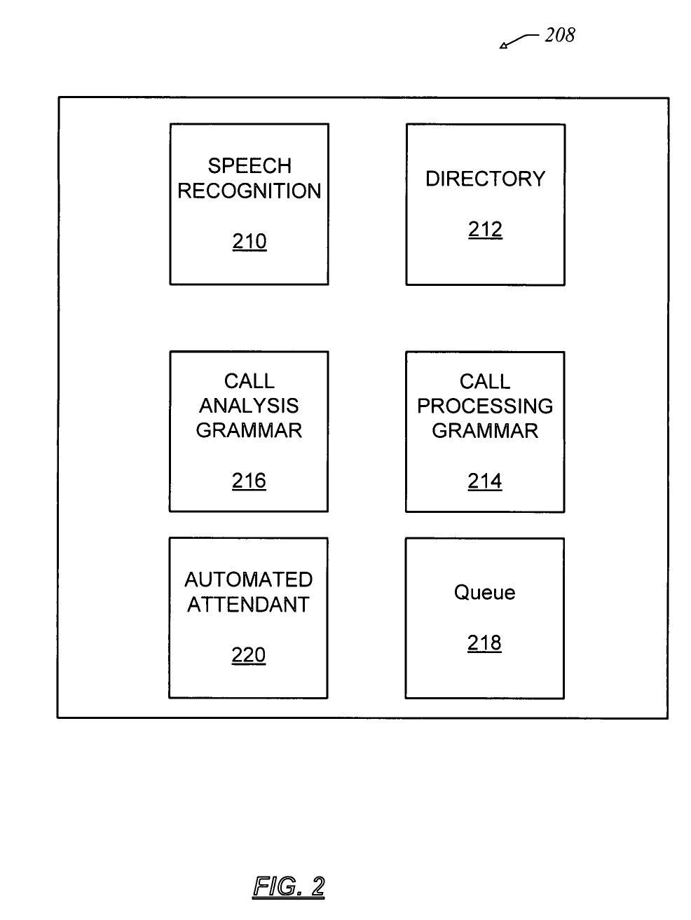

FIG. 2 is a block diagram of functional components of an automated attendant system 208 comprised in servers 140, 142, and 144. Automated attendant system 208 may be, for example, comprised in the functionality that is provided by a unified messaging server.

Automated attendant system 208 may comprise, for example, speech recognition/generation component 210, directory 212, call processing grammar 214, call analysis grammar 216, voice input queue 218, and automated attendant server 220. Speech recognition/generation component 210 operates to interpret voice inputs into a format that may be further processed by automated attendant 208. Also, speech recognition/generation component 210 may operate to play pre-recorded audio to callers. Speech recognition/generation component 210 may comprise any suitable software and/or hardware that is operable to interpret received voice inputs.

Directory 212 is a database of persons, organizations, and/or positions that are known to exist and to whom calls may be forwarded by automated attendant 208. Directory 212 may comprise, for example, the employees and/or departments in a particular organization. For each entity, e.g, person or department, stored in directory 212, directory 212 may comprise at least one phone number which identifies the phone number to which calls directed to the particular entity ought to be forwarded. Directory 212 may be stored in any data storage construct such as, for example, a relational or object database, suitable for storing and organizing information.

Call processing grammar 214 comprises words and groups of words, i.e. phrases, that are expected to be received in voice inputs. Also, call processing grammar 214 may designate actions to be taken upon receipt of a voice input comprising a particular word or phrase. For example, call processing grammar 214 may comprise the word “receptionist” and may designate or comprise a link to a phone number to which calls that are directed to the receptionist ought to be communicated. Upon receiving a voice input identifying the word “receptionist,” system 208 may identify the voice input as a valid input by referring to grammar 214 and transfer the call to a phone number corresponding to the receptionist. The phone number may be stored in call processing grammar 214 and/or may be stored in directory 212.

Call processing grammar 214 may also comprise phrases that signify an action that the user wishes to take. For example, call processing grammar 214 may comprise the phrase “service call.” Upon receiving a voice input identifying the phrase “service call,” system 208 may transfer the call to a phone number corresponding to the department that is designated to handle service requests. In some instances, the action identified to be taken upon receipt of a particular voice input is to play a further prompt for additional information. For example, if the voice input identified “rebate request,” the call processing grammar 214 may specify that a further prompt requesting product information should be played to the user.

Call processing grammar 214 may be configured to identify synonyms. For example, not only might the call processing grammar 214 comprise the word “receptionist,” but it also might comprise words and phrases such as “operator” and “front desk.” All of these words and phrases are designated in call processing grammar 214 to refer to the same action, which may be to communicate the call to a particular phone number. Similarly, in addition to referring to the phrase “service call,” call processing grammar 214 may also comprise the phrases “need help” and “help with broken equipment.” Each of these phrases may be designated in call processing grammar 214 to correspond to the action of calling the same phone number. Accordingly, if a voice input should identify any one of these, the same action will be taken.

In an illustrative embodiment, call processing grammar 214 may maintain a relatively small number of words and phrases. In other words, grammar 214 may be relatively “flat.” Limiting the number of words or phrases allows for quickly identifying if the words in a voice input exist in grammar 214. A “flat” grammar results in a more natural user experience.

Call analysis grammar 216 comprises words and phrases, including those that may not be expected to be included in the voice inputs received. Call analysis grammar 216 may be employed, for example, when a voice input comprises words and/or phrases that are not included in the call processing grammar 214. In such an instance, the words and phrases in the voice input may be identified using call analysis grammar 216. Employing call analysis grammar 216 as a separate component from call processing grammar 214 allows for call processing grammar 214 to comprise a relatively small number of words and/or phrases that are expected to be received in voice inputs, while also allowing for processing of user inputs containing words outside of grammar 214. Further, maintaining a small number of words in call processing grammar 214 may result in less computing resources being consumed and provide increased accuracy.

Call processing grammar 214 and call analysis grammar 216 may be stored in any data storage construct such as, for example, a relational or object database, suitable for storing and organizing information.

Queue 218 contains a record of the voice inputs that have been received but for which matching words or phrases could not be located in call processing grammar 214. After a voice input is received and determined not to correspond to words or phrases in grammar 214, the voice input is placed in queue 218 for further analysis. Queue may also comprise an indication of the actions that were ultimately taken in response to each of the particular calls.

Automated attendant server 220 interfaces with speech recognition component 210, directory 212, call processing grammar 214, call analysis grammar 216, and queue 218 in order to receive user voice inputs and process the inputs as described herein. Automated attendant server 220 prompts users for inputs, receives voice inputs from the users, initiates actions in response to voice inputs that employ words and phrases comprised in call processing grammar 214, and facilitates updating call processing grammar 214 to account for unexpected words and/or phrases that are received in user voice inputs. Automated attendant server 220 may facilitate updating call processing grammar 214 by, for example, queuing voice inputs containing unexpected words and/or phrases in queue 218 for analysis and subsequently adding words and/or phrases to call processing grammar 214. Automated attendant server 220 may compare unexpected words and/or phrases for a call that ultimately was directed to a particular phone number to the unexpected words and/or phrases in previously received voice inputs that were ultimately directed to that same phone number. As a result of the comparison, automated attendant server 220 may identify words and/or phrases for addition to call processing grammar 214.

Automated Attendant Grammar Tuning Method

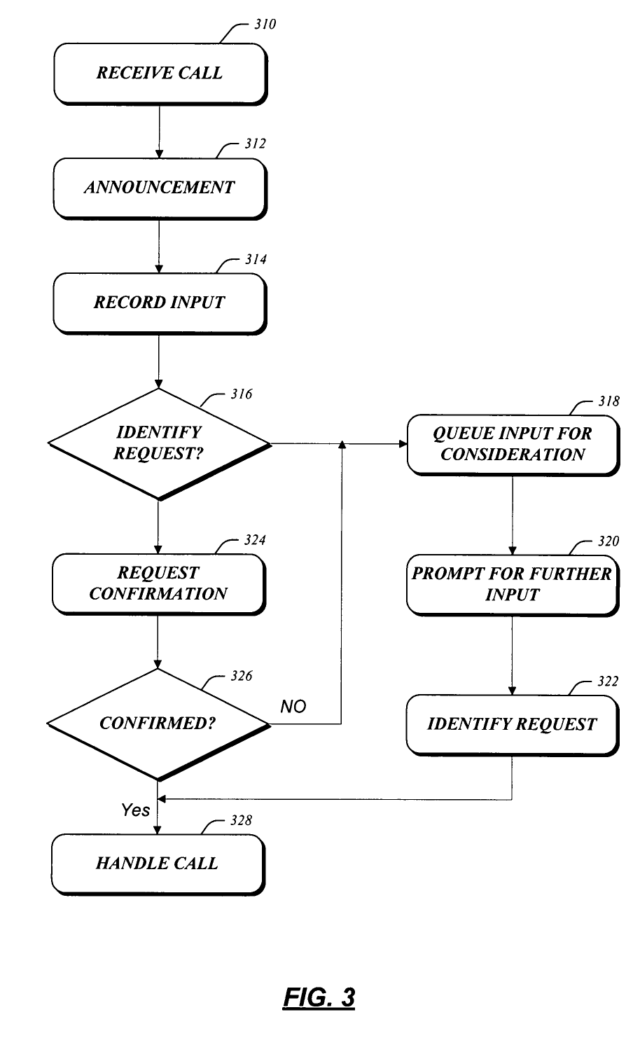

FIG. 3 is a flow diagram of an illustrative process for receiving calls for which automated attendant servicing is to be provided. At step 310, a call is received at automated attendant system 208 which may be operating on one or more of servers 140, 142, and 144. The call may have been routed through gateway 120, and may have originated from, for example, network 108.

At step 312, automated attendant server 220 interfaces with speech recognition and generation component 210 to cause an announcement to be played to the caller. The announcement may prompt the user to make an input identifying the action that he or she wishes to take. For example, the announcement may prompt the user to identify a person to whom he or she wishes to speak, e.g., “please say the name of the person with whom you wish to speak.” The announcement may prompt the user to identify the particular department or position to whom he or she wishes to speak, e.g., “please say the name of the department to whom your call should be directed.” The announcement may more generally request that the user identify the reason for his or her call, e.g., “how can we help you?”

At step 314, automated attendant server 220 records the caller's voice input. The voice input may be stored, for example, in random access memory and/or in a database.

At step 316, automated attendant server 220 processes the voice input to identify whether the voice input corresponds to expected words and/or phrases in call processing grammar 214. Automated attendant server 220 determines whether the words used in the voice input signify an action to be taken as specified in call processing grammar 214. For example, a voice input may specify that the caller wishes to speak with a particular person. Automated attendant server 220 determines whether the specified person is identified in call processing grammar 214. In another example, a voice input may specify that the caller wishes to speak with a particular department. Automated attendant server 220 determines whether the words used in the input to specify the department are included in call processing grammar 214. In still another example, a voice input may specify that the call requests assistance with a particular problem. Automated attendant sever 220 determines whether or not the words used in the voice input to identify the particular problem are included in call processing grammar 214.

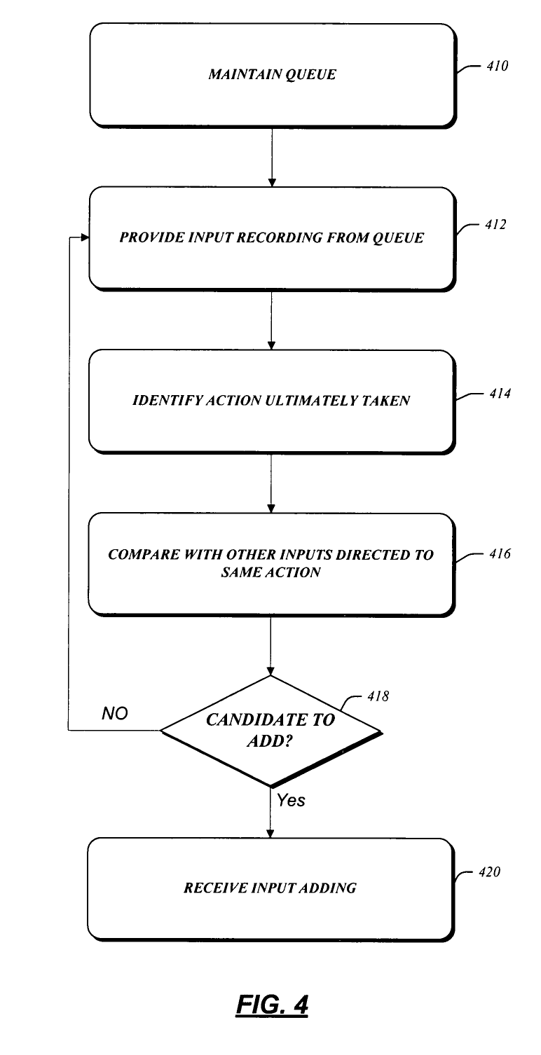

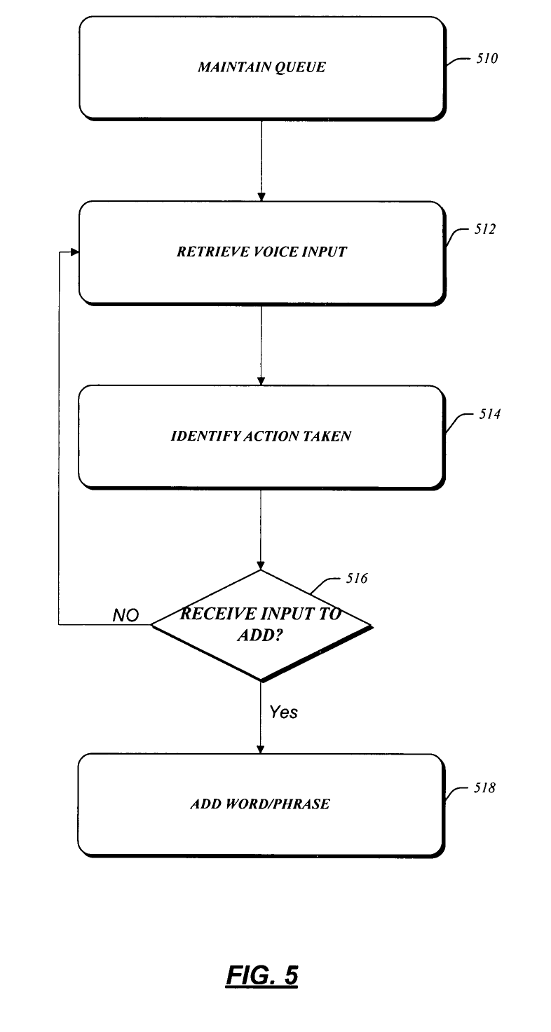

If the words and/or phrases in the voice input do not correspond to the expected words and/or phrases in call processing grammar 214, at step 318 automated assistant queues the voice input for further consideration. For example, the voice input may be stored in queue 218. Subsequent consideration of the voice input may involve identifying whether or not call processing grammar 214 should be updated to include words and/or phrases included in the particular voice input as illustrated in FIGS. 4 and 5.

After queuing the voice input for further consideration, and because the initial attempt to do so was unsuccessful, at step 320 automated attendant 220 prompts the user for further input in order to identify the purpose of the call. For example, automated attendant 220 may announce to the caller that the initial request was unrecognized and ask the user to restate the request. Alternatively, automated attendant 220 may transfer the call to a live operator to prompt for the input. Ultimately, at step 322, the desired action requested by the caller is identified and the requested action stored with the initial voice input in queue 218 for further processing. At step 328, automated attendant 220 takes the requested action, which may be, for example, communicating the call to a phone extension for a particular person or organization.

If at step 316 automated attendant 220 identifies words and/or phrases in the voice input as corresponding to entries in call processing grammar 214, at step 324 automated attendant 220 announces a confirmation of the action that automated attendant has understood the caller to have requested. For example, automated attendant 220 may request that the caller confirm that he or she wishes to speak with a particular person or a particular department, e.g., “you want to speak with Mr. John Smith?”.

At step 326, automated attendant 220 determines whether the caller has confirmed the desired action as understood by automated attendant 220. If confirmation is not received, automated attendant proceeds to step 318 and adds the voice input to queue 218 for further consideration. Thereafter, automated attendant 220 proceeds as noted above at steps 320 and 322.

If at step 326 confirmation of the requested action is received, at step 328 automated attendant 220 takes the requested action, which may be, for example, communicating the call to a phone extension for a particular person or organization.

FIG. 4 is a flow diagram of an illustrative process for analyzing voice inputs received by an illustrative automated attendant system 208. At step 410, automated attendant 220 maintains a queue 218 of voice inputs that have been received but for which corresponding words and/or phrases in call processing grammar 214 were not identified.

At step 412, automated attendant 220 may retrieve a particular voice input from the queue 218. At step 414, automated attendant 220 identifies the action ultimately taken for the particular voice input. For example, the action ultimately taken may have been to communicate a call to a particular number or to play a particular prompt. The action taken may be retrieved from queue 218.

At step 416, automated attendant 220 compares the particular voice input with the voice inputs that were previously received, found not to correspond to words and/or phrases in call processing grammar 214, and determined ultimately to have requested the same action as the particular voice input. For example, if the caller's voice input of “service request” is found not to correspond to entries in call processing grammar 214 and the action ultimately taken for the call was to communicate the call to the customer service department, at step 416 automated attendant 220 compares the voice input “service request” with previously received voice inputs that likewise were found not to have corresponding entries in processing grammar 214 and which were also ultimately communicated to the customer service department.

At step 418, automated attendant 220 identifies whether the voice input comprises words and/or phrases that are candidates to be added or promoted to the call processing grammar 214. If, for example, it is determined that the voice input contains a word or phrase that is the same as those in one or more previous voice calls that ultimately resulted in the same action, at step 418, automated attendant 220 may identify the particular word or phrase for addition to the call processing grammar 214. By way of a particular example, if a caller's voice input was “service request” and the call was ultimately routed to the customer service department, and a previous voice input similarly included the phrase “service request” and was likewise routed to the customer service department, at step 418 automated attendant 220 may identify the phrase “service request” to be added to call processing grammar 214.

At step 420, automated attendant 220 may receive an input specifying that the identified word or phrase be added to the words and phrases in call processing grammar 214 that are expected to be received. For example, an input may be received from an administrator, or possibly even a user, operator, or agent, of the automated attendant system that the identified word or phrase be added to the call processing grammar 214. Once the particular word or phrase is added to grammar 214, subsequent voice inputs that comprise the particular word or phrase can be handled automatically by automated attendant 220.

FIG. 5 is a flow diagram of another illustrative process for analyzing voice inputs received by an illustrative automated attendant service. At step 510, automated attendant 220 maintains queue 218 of voice inputs that have been received but for which corresponding words and/or phrases in call processing grammar 214 were not identified. Automated attendant 220 may present the items in queue 218 to a user so that he or she can select a particular voice input for analysis.

At step 512, automated attendant 220 may, in response to a user request, retrieve and present a voice input from queue 218. By way of a particular example, automated attendant 220 may, in response to a user request, retrieve and present a voice input that specified “service request.”

At step 514, automated attendant 220 identifies the action ultimately taken for the particular voice input and presents the action to the user. For example, automated attendant 220 identifies from the information stored with the particular voice input in queue 218 whether the associated call was eventually routed to a particular person or organization or whether a particular service was provided in response to the voice input. By way of a particular example, automated attendant 220 may identify and present to the user that a particular voice input—“service request”—ultimately resulted in the call being communicated to the customer service department.

At step 516, automated attendant 220 determines whether a user input has been received indicating that a particular word or phrase should be added to call processing grammar 214. A user may determine that a particular word or phrase should be added to call processing grammar 214 where, for example, the word or phrases used in the particular voice input are synonyms for words that already exist in grammar 214. Alternatively, a user may determine that a particular word or phrase is a sensible user input and likely to be used by other callers.

If at step 516, no input is received indicating the particular word or phrase should be added to call processing grammar 214, processing continues at step 512.

If at step 516, a user input is received indicating a particular word or phrase should be added to call processing grammar 214, at step 518 the particular word or phrase is added to call processing grammar 214. Once the particular word or phrase is added to grammar 214, subsequent voice inputs that comprise the particular word or phrase can be handled automatically by automated attendant 220.

Example Computing Environment

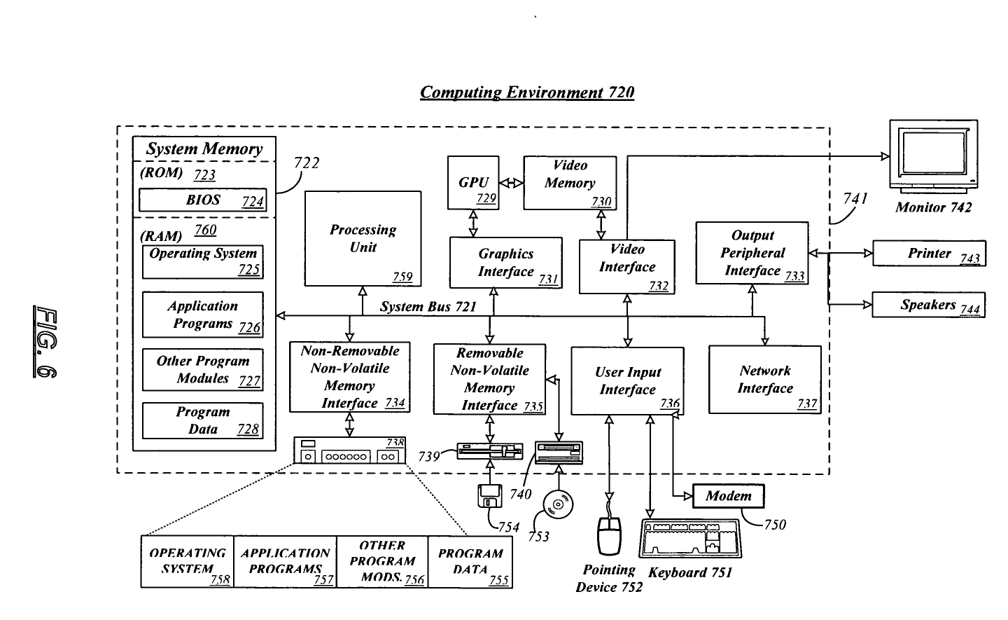

FIG. 6 depicts an example computing environment 720 that may be used in an exemplary computing arrangement 100. Example computing environment 720 may be used in a number of ways to implement the disclosed methods for automated attendant servicing described herein. For example, computing environment 720 may operate as computer servers 140, 142, 144 to provide automated attendant servicing. In an example embodiment, computing environment 720 may operate as gateway 120.

Computing environment 720 is only one example of a suitable computing environment and is not intended to suggest any limitation as to the scope of use or functionality of the subject matter disclosed herein. Neither should the computing environment 720 be interpreted as having any dependency or requirement relating to any one or combination of components illustrated in the example operating environment 720.

Aspects of the subject matter described herein are operational with numerous other general purpose or special purpose computing system environments or configurations. Examples of well known computing systems, environments, and/or configurations that may be suitable for use with the subject matter described herein include, but are not limited to, personal computers, server computers, hand-held or laptop devices, portable media devices, multiprocessor systems, microprocessor-based systems, set top boxes, programmable consumer electronics, network PCs, minicomputers, mainframe computers, distributed computing environments that include any of the above systems or devices, and the like.

An example system for implementing aspects of the subject matter described herein includes a general purpose computing device in the form of a computer 741. Components of computer 741 may include, but are not limited to, a processing unit 759, a system memory 722, and a system bus 721 that couples various system components including the system memory to the processing unit 759. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 741 typically includes a variety of computer readable media. Computer readable media can be any available media that can be accessed by computer 741 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 741. Communication media typically embodies computer readable instructions, data structures, program modules or other data in a modulated data signal such as a carrier wave or other transport mechanism and includes any information delivery media. The term “modulated data signal” includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 722 includes computer storage media in the form of volatile and/or nonvolatile memory such as read only memory (ROM) 723 and random access memory (RAM) 760. A basic input/output system 724 (BIOS), containing the basic routines that help to transfer information between elements within computer 741, such as during start-up, is typically stored in ROM 723. RAM 760 typically contains data and/or program modules that are immediately accessible to and/or presently being operated on by processing unit 759. By way of example, and not limitation, FIG. 6 illustrates operating system 725, application programs 726, other program modules 727, and program data 728.

Computer 741 may also include other removable/non-removable, volatile/nonvolatile computer storage media. By way of example only, FIG. 6 illustrates a hard disk drive 738 that reads from or writes to non-removable, nonvolatile magnetic media, a magnetic disk drive 739 that reads from or writes to a removable, nonvolatile magnetic disk 754, and an optical disk drive 740 that reads from or writes to a removable, nonvolatile optical disk 753 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 738 is typically connected to the system bus 721 through a non-removable memory interface such as interface 734, and magnetic disk drive 739 and optical disk drive 740 are typically connected to the system bus 721 by a removable memory interface, such as interface 735.

The drives and their associated computer storage media discussed above and illustrated in FIG. 6, provide storage of computer readable instructions, data structures, program modules and other data for the computer 741. In FIG. 6, for example, hard disk drive 738 is illustrated as storing operating system 758, application programs 757, other program modules 756, and program data 755. Note that these components can either be the same as or different from operating system 725, application programs 726, other program modules 727, and program data 728. Operating system 758, application programs 757, other program modules 756, and program data 755 are given different numbers here to illustrate that, at a minimum, they are different copies. A user may enter commands and information into the computer 741 through input devices such as a keyboard 751 and pointing device 752, commonly referred to as a mouse, trackball or touch pad. Other input devices (not shown) may include a microphone, joystick, game pad, satellite dish, scanner, or the like. These and other input devices are often connected to the processing unit 759 through a user input interface 736 that is coupled to the system bus, but may be connected by other interface and bus structures, such as a parallel port, game port or a universal serial bus (USB). A monitor 742 or other type of display device is also connected to the system bus 721 via an interface, such as a video interface 732. In addition to the monitor, computers may also include other peripheral output devices such as speakers 744 and printer 743, which may be connected through an output peripheral interface 733.

Thus a system for providing automated attendant servicing has been disclosed. The system provides a feedback loop for adding words and phrases to the set of words and phrases against which user inputs are analyzed.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

What is claimed:

1. A method of processing voice calls, comprising:
receiving a call;
communicating an announcement in response to the call;
recording a voice input;
determining if the voice input corresponds to words in a database of expected voice inputs;
if the voice input corresponds to words in a database of expected voice inputs, identifying an action to be taken in response; and
if the voice input does not correspond to words in a database of expected inputs, adding the recorded voice input to a queue of inputs for analysis.

2. The method of claim 1, wherein identifying an action to be taken in response comprises identifying a phone number to which the call is to be communicated.

3. The method of claim 1, further comprising:
if the voice input does not correspond to words in a database of expected inputs, communicating a prompt for additional input.

4. The method of claim 1, further comprising:
if the voice input does not correspond to words in a database of expected inputs, adding words from the voice input to the database.

5. The method of claim 1, further comprising:
if the voice input does not correspond to words in a database of expected inputs
identifying for the voice input an entity to which the call was ultimately directed,
identifying previously received voice inputs directed to the entity,
identifying words occurring in both the voice input and the previously received voice inputs, and
identifying words occurring in both the voice input and the previously received voice inputs for addition to the database.

6. The method of claim 5, wherein identifying words occurring in both the voice input and the previously received voice inputs for addition to the database, comprises identifying words and at least one of a phone number, a person, and an organization for storage in relation to the words.

7. The method of claim 5, further comprising receiving an input providing instruction to add to the database the words occurring in both the voice input and the previously received voice inputs.

8. The method of claim 1, further comprising:
if the voice input does not correspond to words in a database of expected inputs,
identifying for the voice input an extension to which the call was ultimately directed,
providing the voice input, and
receiving input identifying for addition to the database words occurring in the voice input.

9. The method of claim 8, wherein identifying for addition to the database words occurring in the voice input comprises identifying for addition to the database words and at least one of a phone number, a person, and an organization for storage in relation to the words.

10. The method of claim 8, wherein recording a voice input comprises recording a voice input comprising a phrase,
wherein determining if the voice input corresponds to words in a database of expected voice inputs comprises determining if the voice input corresponds to a phrase in a database of expected voice inputs, and
wherein receiving input identifying for addition to the database words occurring in the voice input comprises receiving input identifying for addition to the database a phrase occurring in the voice input.

11. A method of processing voice calls, comprising:
maintaining a database of words expected in voice inputs, said database comprising for particular words phone numbers for communicating a call in response to a voice input comprising the particular words;
receiving a call;
receiving in connection with the call a voice input comprising a word;
identifying the received word is missing from the database of words expected in voice inputs; and
adding the received word to the database.

12. The method of claim 11, further comprising identifying a phone number to which the call is communicated,
wherein adding the received word to the database comprises adding the phone number to the database stored in relation to the received word.

13. The method of claim 11, wherein maintaining a database of words expected in voice inputs comprises maintaining a database of phrases expected in voice inputs,
wherein receiving in connection with the call a voice input comprising a word comprises receiving an input comprising a phrase,
wherein identifying the received word is missing from the database of words expected in voice inputs comprises identifying the received phrase is missing from the database, and
wherein adding the received word to the database comprises adding the received phrase to the database.

14. The method of claim 11, further comprising:
identifying previously received voice inputs directed to the phone number comprising the received word; and
identifying for addition to the database the received word upon identifying previously received voice inputs directed to the phone number comprising the received word.

15. The method of claim 11, further comprising
receiving an input indicating the received word is to be added to the database.

16. A voice automated attendant system, comprising:
a database of words expected to be received in a voice input; and
a server comprising computer-readable instructions for receiving a call, receiving a voice input, determining whether the voice input corresponds to words expected to be received in a voice input in the database, and updating the database of words expected to be received in a voice input.

17. The voice automated attendant system of claim 16, further comprising computer-readable instructions for performing speech recognition on the voice input.

18. The voice automated attendant system of claim 16, wherein said database comprises for entries in the database actions to be taken in response to receiving a voice input comprising a word having an entry in the database.

19. The voice automated attendant system of claim 16, wherein said server further comprises instructions for identifying a phone extension to which the call was forwarded, identifying for the phone extension previously received voice inputs, and identifying words in the voice input corresponding to words in the previously received voice inputs.

20. The voice automated attendant system of claim 16, wherein said computer-readable instructions for updating the database of words expected to be received in a voice input comprises instructions for updating the database of words with a word and a corresponding phone extension.
